(19) United States
(12) Patent Application Publication
(10) Pub. No.: US 2026/0329486 A1
(43) Pub. Date: Oct. 22, 2026

(54) METHOD AND NON-TRANSITORY COMPUTER-READABLE STORAGE MEDIUM AND APPARATUS FOR OPERATING HYBRID NAND FLASH UNITS

(71) Applicant: Silicon Motion, Inc., Zhubei City (TW)

(72) Inventor: YU-WEI CHYAN, Hsinchu City (TW)

(73) Assignee: Silicon Motion, Inc., Zhubei City (TW)

(21) Appl. No.: 19/313,975

(22) Filed: Aug. 29, 2025

Related U.S. Application Data
(60) Provisional application No. 63/792,533, filed on Apr. 22, 2025.

(51) Int. Cl. G06F 3/06

(52) U.S. Cl. CPC G06F 3/0679; G06F 3/0604; G06F 3/0655

(57) ABSTRACT

The invention introduces a method for operating hybrid NAND flash units, performed by a processing unit of a flash controller, to include: connecting to a flash module including a first NAND flash unit, a second NAND flash unit, a third NAND flash unit and a fourth NAND flash unit; and programming user data obtained from a host side into the flash module. First areas of single level cell (SLC) regions of the first to the fourth NAND flash units jointly provide cache space for triple level cell (TLC) regions of the first and third NAND flash units, and second areas of the SLC regions of the first to the fourth NAND flash units jointly provide cache space for quad-level cell (QLC) regions of the second and the fourth NAND flash units.

### CROSS-REFERENCE TO RELATED APPLICATIONS

This application claims the benefit of priority to U.S. Provisional Application No. 63/792,533, filed on Apr. 22, 2025; the entirety of which is incorporated herein by reference for all purposes.

### BACKGROUND

The disclosure generally relates to storage devices and, more particularly, to a method, a non-transitory computer-readable storage medium and an apparatus for operating hybrid NAND flash units.

Flash memory devices typically include NOR flash devices and NAND flash devices. NOR flash devices are random access—a host side accessing a NOR flash device can provide the device any address on its address pins and immediately retrieve data stored in that address on the device's data pins. NAND flash devices, on the other hand, are not random access but serial access. It is not possible for NAND to access any random address in the way described above. Instead, the host side has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word.

### SUMMARY

In an aspect of the invention, an embodiment introduces a method for operating hybrid NAND flash units, performed by a processing unit of a flash controller, to include the following steps: connecting to a flash module including a first NAND flash unit, a second NAND flash unit, a third NAND flash unit and a fourth NAND flash unit; and programming user data obtained from a host side into the flash module.

In another aspect of the invention, an embodiment introduces a non-transitory computer-readable storage medium having stored therein program code that, when loaded and executed by a processing unit of a flash controller, causes the processing unit to perform the method for operating hybrid NAND flash units, as described above.

In still another aspect of the invention, an embodiment introduces an apparatus for programming data into hybrid NAND flash units, to include: a flash interface (I/F), coupled to a flash module including a first NAND flash unit, a second NAND flash unit, a third NAND flash unit and a fourth NAND flash unit; and a processing unit, coupled to the flash I/F. The processing unit is arranged operably to: connecting to the flash module; and program user data obtained from a host side into the flash module through the flash I/F.

Inside the flash module, a first channel is connected to the first NAND flash unit and the second NAND flash unit, a second channel is connected to the third NAND flash unit and the fourth NAND flash unit, the first NAND flash unit and the third NAND flash unit are activated by a first chip enable signal, and the second NAND flash unit and the fourth NAND flash unit are activated by a second chip enable signal. Storage space of the first NAND flash unit includes a first region and a second region, storage space of the second NAND flash unit comprises a third region and a fourth region, storage space of the third NAND flash unit includes a fifth region and a sixth region, and storage space of the fourth NAND flash unit comprises a seventh region and an eighth region. Storage space of the first region includes a first area and a second area, storage space of the third region includes a third area and a fourth area, storage space of the fifth region includes a fifth area and a sixth area, and storage space of the seventh region includes a seventh area and an eighth area. The first area, the third area, the fifth area and the seventh area jointly provide cache space for the second region and the sixth region, and the second area, the fourth area, the sixth area and the eighth area jointly provide cache space for the fourth region and the eighth region.

The first region, the third region, the fifth region and the seventh region are single level cell (SLC) regions, the second region and the sixth region are triple level cell (TLC) regions, the fourth region and the eighth region are quad-level cell (QLC) regions.

Both the foregoing general description and the following detailed description are examples and explanatory only, and are not restrictive of the invention as claimed.

### BRIEF DESCRIPTION OF THE DRAWINGS

FIG. 1 is the system architecture of an electronic apparatus according to an embodiment of the invention.

FIG. 2 is a schematic diagram illustrating a flash module according to an embodiment of the invention.

FIG. 3 is a schematic diagram showing the hardware architecture of a portion of a NAND flash unit according to an embodiment of the invention.

FIG. 4 is a schematic diagram showing a hybrid architecture established in a flash module according to an embodiment of the invention.

FIG. 5 is a schematic diagram illustrating data access operations of the hybrid architecture of the flash module in some implementations.

FIGS. 6 and 7 are schematic diagrams illustrating data access operations of the hybrid architecture of the flash module according to an embodiment of the invention.

FIG. 8 is a flowchart illustrating a method for a fast-programming process in data access operations of the hybrid architecture of the flash module, which is performed by a processing unit of a flash controller, according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that changes may be made in the function and arrangement of elements without departing from the spirit and scope of the application as set forth in the claims.

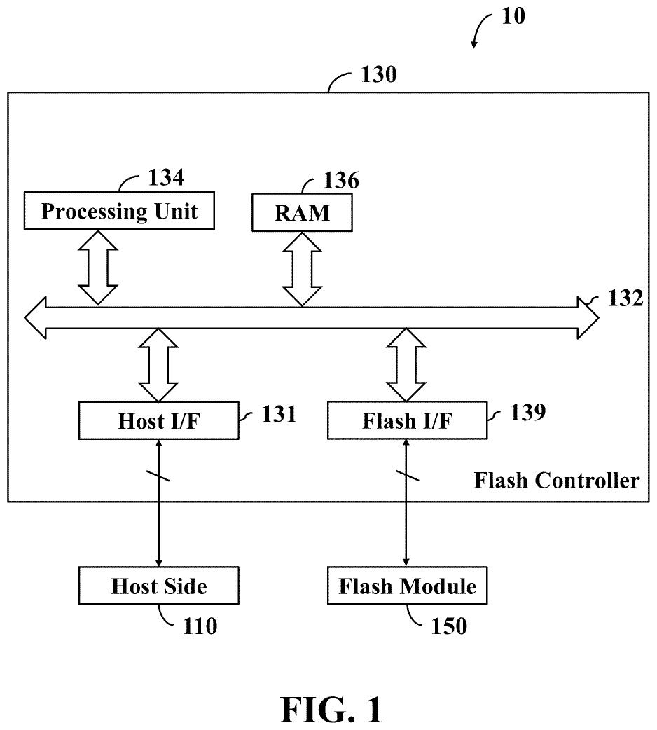

Refer to FIG. 1. The electronic apparatus 10 includes the host side 110, the flash controller 130 and the flash module 150, and the flash controller 130 and the flash module 150 may be collectively referred to as a device side. The electronic apparatus 10 may be included in a Personal Computer (PC), a laptop PC, a tablet PC, a mobile phone, a digital camera, a digital recorder, a smart television, a smart freezer, an automotive electronics system or other consumer electronic products. The host side 110 and the host interface (I/F) 131 of the flash controller 130 may communicate with each other by Universal Serial Bus (USB), Advanced Technology Attachment (ATA), Serial Advanced Technology Attachment (SATA), Peripheral Component Interconnect Express (PCI-E), Universal Flash Storage (UFS), Embedded Multi-Media Card (eMMC) protocol, or others. The flash I/F 139 of the flash controller 130 and the flash module 150 may communicate with each other by a Double Data Rate (DDR) protocol, such as Open NAND Flash Interface (ONFI), DDR Toggle, or others. The flash controller 130 includes the processing unit 134 and the processing unit 134 may be implemented in numerous ways, such as with general-purpose hardware (e.g., a microcontroller unit, a single processor, multiple processors or graphics processing units capable of parallel computations, or others) that is programmed using firmware and/or software instructions to perform the functions recited herein. The processing unit 134 may receive host commands from the host side 110 through the host I/F 131, such as write commands, read commands, discard commands, erase commands, etc., schedule and execute the host commands. The flash controller 130 includes the Random Access Memory (RAM) 136, which may be implemented in a Dynamic Random Access Memory (DRAM), a Static Random Access Memory (SRAM), or the combination thereof, for allocating space as a data buffer storing user data (also referred to as host data) that has been obtained from the host side 110 and is to be programmed into the flash module 150, and that has been read from the flash module 150 and is to be output to the host side 110. The RAM 136 stores necessary data in execution, such as variables, data tables, data abstracts, host-address to flash-address mapping (H2F) tables, flash-address to host-address mapping (F2H) tables, or others. The flash I/F 139 includes a NAND flash controller (NFC) to provide functions that are required to access the flash module 150, such as a command sequencer, a Low Density Parity Check (LDPC) encoder/decoder, etc.

The flash controller 130 may be equipped with the bus architecture 132 to couple components to each other to transmit data, addresses, control signals, etc. The components include but not limited to the host I/F 131, the processing unit 134, the RAM 136 and the flash I/F 139. A direct memory access (DMA) circuitry of a component moves data between specific components through the bus architecture 132 according to instructions or control signals. For example, a DMA circuitry of the host I/F 131 or the flash I/F 139 may migrate data in a specific data buffer thereof to a specific address of the RAM 136, migrate data in a specific address of the RAM 136 to a specific data buffer thereof, and so on.

The flash module 150 provides huge storage space typically in hundred Gigabytes (GBs), or even several Terabytes (TBs), for storing a wide range of user data, such as high-resolution images, video files, etc. The flash module 150 includes control circuitries and memory arrays containing memory cells, such as being configured as Single Level Cells (SLCs), Multi-Level Cells (MLCs), Triple Level Cells (TLCs), Quad-Level Cells (QLCs), or any combinations thereof. The processing unit 134 programs user data into a designated address (a destination address) of the flash module 150 and reads user data from a designated address (a source address) thereof through the flash I/F 139. The flash I/F 139 may use several electronic signals including a data line, a clock signal line and control signal lines for coordinating the command, address and data transfer with the flash module 150. The data line may be used to transfer commands, addresses, read data and data to be programmed; and the control signal lines may be used to transfer control signals, such as Chip Enable (CE), Address Latch Enable (ALE), Command Latch Enable (CLE), Write Enable (WE), etc.

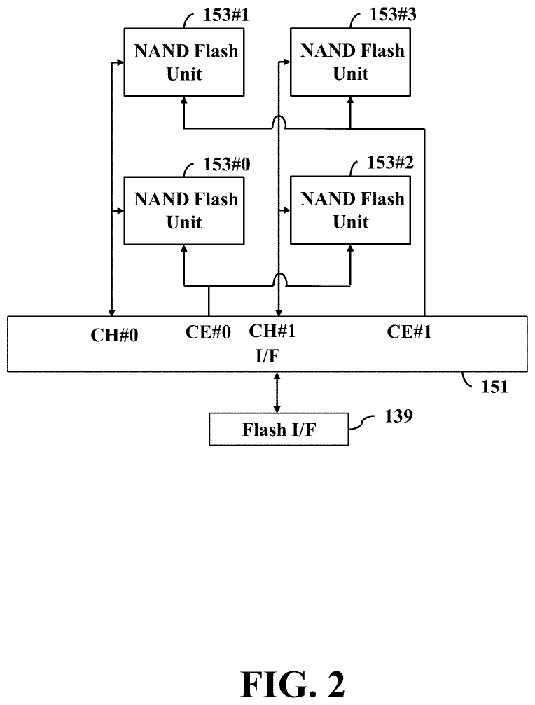

Refer to FIG. 2. The I/F 151 of the flash module 150 may include four I/O channels (hereinafter referred to as channels) CH#0 to CH#1 and each is connected to two NAND flash units, for example, the channel CH#0 is connected to the NAND flash units 153#0 and 153#1, the channel CH#1 is connected to the NAND flash units 153#2 and 153#3. Each NAND flash unit includes one or more dies and every die may be identified by a Logical Unit Number (LUN) or a similar but different identifier (ID). Each die includes one or more data planes and each data plane includes hundreds or thousands of physical blocks. The flash I/F 139 can issue one of the CE signals CE#0 to CE#1 through the I/F 151 to activate the NAND flash units 153#0 to 153#1, or the NAND flash units 153#2 to 153#3, and read data from or program data into the activated NAND flash units in parallel with an interleave manner. The flash I/F 139 can transmit write commands, designated physical addresses and data through data buses in the channel CH#0 or CH#1 for programming the data into the designated physical address of corresponding NAND flash units (or a corresponding die). The flash I/F 139 can transmit read commands and designated physical addresses through the data buses in the channel CH#0 or CH#1, and read data of the designated physical address from a corresponding NAND flash unit (or a corresponding die) through the data buses in the same channel. The arrangement of the flash module 150 as shown in FIG. 2 is only for the illustration purpose, those skilled in the art can modify the flash module 150 to include more channels, and/or provide more NAND flash units in the same channel.

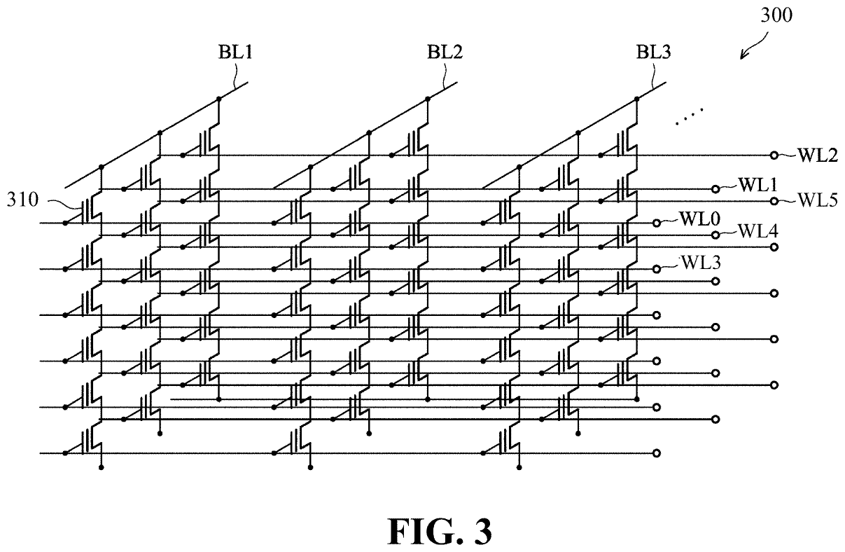

Refer to FIG. 3 showing the hardware architecture of a portion of a NAND flash unit. Each NAND flash unit may contain a plurality of memory blocks (e.g. the memory block 300) and the memory block 300 contains multiple memory cells, such as floating gate transistors (e.g. the floating gate transistor 310), or other charge trap devices. The structure of the memory block 300 includes bit lines and word lines. For brevity, only the bit lines BL1 to BL3 and the word lines WL0 to WL5 are labeled in FIG. 3. For example, the floating gate transistors on each of the word lines WL0 to WL2 and WL3 to WL5 store one or more pages of data.

Each die may include multiple data planes, each data plane may include multiple physical blocks. In order to improve the data programming and data reading efficiency, specific physical pages of multiple physical blocks across multiple NAND flash units are organized into one super page (SP). For example, in the exemplary configuration as shown in FIG. 2, each NAND flash unit has one die, each die includes two data planes, each data plane has multiple physical blocks and each physical block includes multiple physical page individually storing four kilobytes (KB) of data. One SP stores user data of 32 KB (=2 channels×2 CE×2 data planes×4 KB). Specific physical blocks across multiple data planes of multiple NAND flash units are organized into one super block (SB). In some embodiments, any SB may be configured as a Single Level Cell (SLC) SB, every word line (WL) in the SLC SB is configured as a SLC WL, and each SP in each SLC WL is called as SLC SP. In alternative embodiments, any SB may be configured as a Multi-Level Cell (MLC) SB, and every WL in the MLC SB can be configured as a SLC or MLC WL. Each SP in each SLC WL is called SLC SP while each SP in the MLC WL may be a most significant bit (MSB) SP or a least significant bit (LSB) SP. In still alternative embodiments, any SB may be configured as a Triple Level Cell (TLC) SB, and every WL in the TLC SB can be configured as a SLC or TLC WL. Each SP in each SLC WL is called as SLC SP while each SP in the TLC WL may be an MSB SP, a center significant bit (CSB) SP or an LSB SP. In still alternative embodiments, any SB may be configured as a Quad-Level Cell (QLC) SB, and every WL in the QLC SB can be configured as a SLC or QLC WL. Each SP in each SLC WL is called as SLC SP while each SP in the QLC WL may be a top significant bit (TSB) SP, an MSB SP, a CSB SP or an LSB SP.

In some embodiments, one logical block address (LBA) managed by the host side 110 may represent user data of 512 bytes (B), and each physical page may be divided into eight sections in 64B. An LBA number is referred to as a logical address managed by the host side 110. An SB, an SP, a physical block, a physical page and a section may be identified by a super-block number, a super-page number, a physical block number, a physical page number and a section number, respectively, and an arbitrary combination of the numbers is referred to as a physical address of the flash module 150. In alternative embodiments, one LBA managed by the host side 110 may represent user data of 4 kilobytes (KB), and each physical page may be divided into eight sections in 512B. An LBA number is referred to as a logical address managed by the host side 110. An SB, an SP, a physical block, a physical page and a section may be identified by a super-block number, a super-page number, a physical block number, a physical page number and a section number, respectively, and an arbitrary combination of the numbers is referred to as a physical address of the flash module 150. In still alternative embodiments, one host page number managed by the host side 110 may represent user data of 4 KB and each physical page is unnecessary to divide into sections. A host page number is referred to as a logical address managed by the host side 110. An SB, an SP, a physical block and a physical page may be identified by a super-block number, a super-page number, a physical block number and a physical page number, respectively, and an arbitrary combination of the numbers is referred to as a physical address of the flash module 150.

Each physical block is labeled as a data block or a current block according to its function. The processing unit 134 may select an empty physical block in a data plane as the current block for preparing to program user data received from the host side 110. In order to improve the efficiency of data programming, the user data provided by the host side 110 is programmed in parallel into empty pages of the current blocks across multiple NAND flash units (or dies). The processing unit 134 maintains the F2H table for each current block. Each F2H table contains multiple records. Each record stores the information indicating which logical address of user data that is associated with (or mapped by) each physical page in the current block. The records in the F2H table are stored in the order of the page numbers of physical pages in the current block. The logical address may be expressed in a logical block address (LBA), a host page number or other expression and is managed by the host side 110. The processing unit 134 may drive the flash I/F 139 to program the corresponding F2H table in the RAM 136 into the data region of the designated physical page (for example, the last physical page) of one current block after all physical pages of this current block are fully stored in user data or the remaining physical pages of this current block are filled with dummy values. The current block is changed to the data block after the corresponding F2H table has been programmed into the flash module 150 (also referred to as a sealing process), and the user data stored in the data block cannot be modified. Subsequently, the processing unit 134 selects another empty SB as a new current block.

In addition to programming the F2H table into the designated physical page of the current block, the processing unit 134 updates the H2F table according to the content of F2H table, so that the processing unit 134 when executing host read commands searches the H2F table for the physical addresses that user data of particular logical addresses are physically stored in later. The H2F table contains multiple records arranged in the order of the logical addresses and each record stores information indicating which physical address that user data of the corresponding logical address is physically stored in. However, because the RAM 136 cannot provide enough space to store the whole H2F table for the processing unit 134, the whole H2F table is divided into multiple H2F sub-tables and the H2F sub-tables are stored in the flash module 150, so that only necessary H2F sub-table or sub-tables are read from the flash module 150 and stored in the RAM 136 for fast look-up when data read operations are performed in the future.

As the demand for data storage capacity increases, the NAND flash units of the flash module 150 are configured with more and more QLC SBs to replace TLC SBs. Although each QLC SB offers about 33% higher storage density than each TLC SB, the access performance (read/write speeds) of the QLC SP is slower, especially in write-intensive operations, than that of the TLC SP, due to the requirement to manage more voltage levels per cell. The flash controller 130 requires collecting more data in preparation of two-pass programming into QLC SPs, for example, four times data required for TLC SPs. That is, the flash controller 130 needs allocate more space in the RAM 136 to temporarily store data to be programmed into QLC SPs. QLC's tighter voltage margines increases error rates during frequent reads. QLC with higher voltage stress and higher programming steps per cell increases the probability of disturb-related errors compared to TLC. QLC typically retains data for shorter periods (less than a year under power-off conditions) than TLC (up to 1 to 3 years) due to less stable voltage states. Each QLC physical block supports only 100 to 1000 Program/Erase (P/E) cycles while each TLC physical block supports around 1000 to 3000 P/E cycles. Moreover, QLC requires more advanced error correction, wear leveling, and caching mechanism due to higher error rates, making the flash controller 130 more complex.

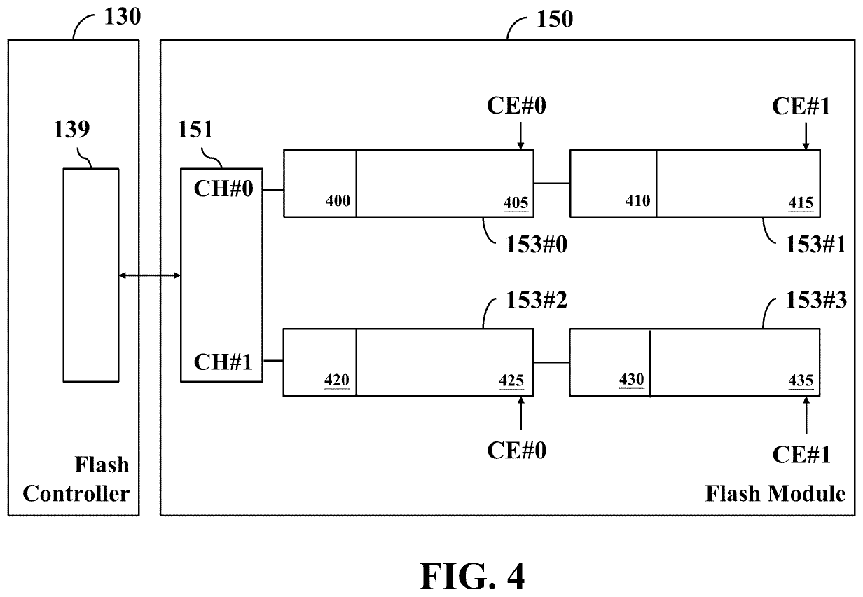

In order to overcome QLC's limitations, an embodiment of the invention proposes a hybrid architecture established in the flash module 150 and a method for programming data into the storage space of the hybrid architecture. The hybrid architecture is employed to leverage SLC cache, TLC buffer zones, and QLC storage with folding mechanisms. Refer to FIG. 4 showing the hybrid architecture established in the flash module 150. The flash module 150 provides at least two channels CH#0 and CH#1 and each channel is connected to at least two NAND flash units. For example, the channel CH#0 is connected to the NAND flash units 153#0 and 153#1, and the channel CH#1 is connected to the NAND flash units 153#2 and 153#3. The NAND flash units 153#0 and 153#2 are provided as TLC NAND flash units and are activated by the CE signal CE#0. A region of each of the TLC NAND flash units 153#0 and 153#2 is allocated for a static SLC cache and the region thereof is referred to as a SLC region, for example, the SLC region 400 or 420. The other region of each of the TLC NAND flash units 153#0 and 153#2 is allocated for TLC buffer and the region thereof is referred to as a TLC region, for example, the TLC region 405 or 425. The NAND flash units 153#1 and 153#3 are provided as QLC NAND flash units and are activated by the CE signal CE#1. A region of each of the QLC NAND flash units 153#1 and 153#3 is allocated for a static SLC cache and the region thereof is referred to as a SLC region, for example, the SLC region 410 or 430. The other region of each of the QLC NAND flash units 153#1 and 153#3 is allocated for QLC storage and the region thereof is referred to as a QLC region, for example, the QLC region 415 or 435. The physical blocks of each SLC region are configured as SLC blocks, and each WL of the SLC block are configured as SLC WL. The physical blocks of each TLC region are configured as TLC blocks, and each WL of the TLC block are configured as TLC WL. The physical blocks of each QLC region are configured as QLC blocks, and each WL of the QLC block are configured as QLC WL.

In some embodiments, every physical block of the SLC regions 400, 410, 420 and 430 is configured as a SLC block only due to reliability and consistency issues. In other words, every physical block of the SLC regions 400, 410, 420 and 430 cannot be configured as either a SLC block or a TLC/QLC block (referred to as dynamic SLC configuration).

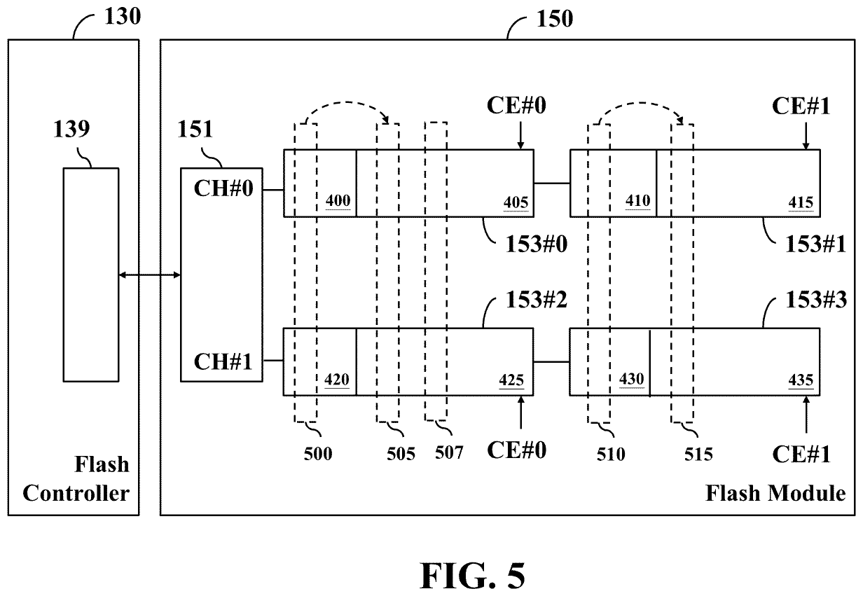

In some implementations, referring to FIG. 5 showing the schematic diagram for data access operations of the hybrid architecture of the flash module 150 under several circumstances, in which the SLC regions 400 and 420 are treated as SLC cache space for the TLC regions 405 and 425, and the SLC regions 410 and 430 are treated as SLC cache space for the QLC regions 415 and 435.

Exemplary data access operations for the hybrid architecture of the flash module 150 are provided as follows: For user data that would be stored in the TLC regions 405 and 425, the user data is programmed into empty pages of physical blocks associated with an SB (e.g. the SB 500) across the SLC regions 400 and 420 in the interleave manner until a total number of empty SBs (or empty physical blocks) of the SLC regions 400 and 420 is less than a predefined SLC-empty-block threshold. Once a total number of empty SBs (or empty physical blocks) of the SLC regions 400 and 420 is less than the predefined SLC-empty-block threshold, a SLC to TLC folding process is performed to collect user data of physical blocks (e.g. the data blocks 500) of the SLC regions 400 and 420 and program the collected user data into empty pages of physical blocks (e.g. the current blocks 505) associated with an SB across the TLC regions 405 and 425 in the interleave manner. Those skilled in the art would comprehend that data of three SPs of the regions 400 and 420 can be collected and programmed into one SP of the regions 405 and 425. After a total number of empty SBs (or empty physical blocks) of the TLC regions 405 and 425 is less than a predefined TLC-empty-block threshold, a TLC direct write process is performed to continuously collect user data of at least three SPs from the host side 110 and program the collected user data into empty pages of physical blocks (e.g. the current blocks 507) associated with an SB across the TLC regions 405 and 425 in the interleave manner. Those skilled in the art would comprehend that user data of three SPs can be collected from the host side 110 and programmed into one empty SP of the TLC regions 405 and 425. After a total number of empty SBs (or empty physical blocks) of the TLC regions 405 and 425 is less than a predefined TLC garbage collection (TLC-GC) threshold, a background GC process and/or a foreground GC process is performed to collect valid user data of data blocks of the TLC regions 405 and 425 and program the collected user data into empty pages of current blocks associated with an SB of the TLC regions 405 and 425 in the interleave manner. The predefined TLC-GC threshold is less than the predefined TLC-empty-block threshold. The interleave programming involves distributing data across the TLC NAND flash units 153#0 and 153#2.

For user data that would be stored in the QLC regions 415 and 435, the user data is programmed into empty pages of physical blocks associated with an SB (e.g. the SB 510) across the SLC regions 410 and 430 in the interleave manner until a total number of empty SBs (or empty physical blocks) of the SLC regions 410 and 430 is less than a predefined SLC-empty-block threshold. Once the total number of empty SBs (or empty physical blocks) of the SLC regions 410 and 430 is less than the predefined SLC-empty-block threshold, a SLC to QLC folding process is performed to collect user data of physical blocks (e.g. the data blocks 510) of the SLC regions 410 and 430 and program the collected user data into empty pages of physical blocks (e.g. the current blocks 515) associated with an SB across the QLC regions 415 and 435 in the interleave manner. Those skilled in the art would comprehend that data of four SPs of the regions 410 and 430 can be collected and programmed into one SP of the QLC regions 415 and 435. After a total number of empty SBs (or empty physical blocks) of the QLC regions 415 and 435 is less than a predefined QLC garbage collection (QLC-GC) threshold, a background GC process and/or a foreground GC process is performed to collect valid user data of data blocks of the QLC regions 415 and 435 and program the collected user data into empty pages of current blocks associated with an SB of the QLC regions 415 and 435 in the interleave manner. The interleave programming involves distributing data across the QLC NAND flash units 153#1 and 153#3.

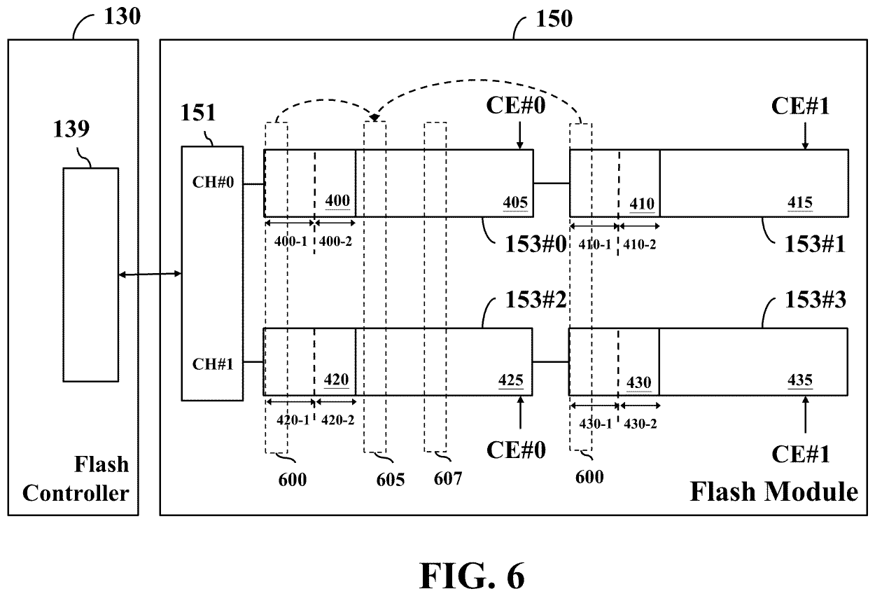

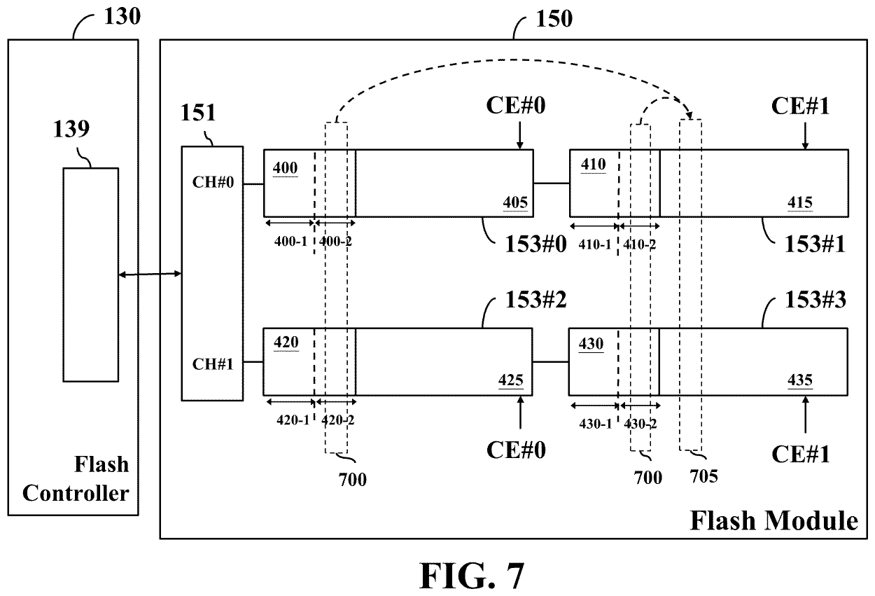

To improve the data throughput and read/write latency of the data access operations as shown in FIG. 5, an embodiment of the invention introduces a new sharing policy of SLC cache space for the TLC regions 405 and 425, and the QLC regions 415 and 435 in the hybrid architecture as shown in FIG. 4, and new data access operations with the new sharing policy of the SLC cache space. Refer to FIGS. 6 and 7 showing the schematic diagrams for the new data access operations with the new sharing strategy under several circumstances. Any memory cell of the SLC regions 400, 410, 420 and 430 is used to store one of two states to indicate one-bit information. Any memory cell of the TLC regions 405 and 425 is used to store one of eight states to indicate three-bit information including the MSB, the CSB and the LSB. Any memory cell of the QLC regions 415 and 435 is used to store one of sixteen states to indicate four-bit information including the TSB, the MSB, the CSB and the LSB. Each of the SLC regions 400, 410, 420 and 430 is divided into two areas: TLC cache; and QLC cache. The TLC cache area 400-1 of the SLC region 400, the TLC cache area 410-1 of the SLC region 410, the TLC cache area 420-1 of the SLC region 420 and the TLC cache area 430-1 of the SLC region 430 jointly provide SLC cache space for the TLC regions 405 and 425. The QLC cache area 400-2 of the SLC region 400, the QLC cache area 410-2 of the SLC region 410, the QLC cache area 420-2 of the SLC region 420 and the QLC cache area 430-2 of the SLC region 430 jointly provide SLC cache space for the QLC regions 415 and 435. For example, storage space of two SBs are allocated for the TLC cache space (for example, the storage space including the TLC cache area 400-1 of the SLC region 400, the TLC cache area 420-1 of the SLC region 420, the TLC cache area 410-1 of the SLC region 410, and the TLC cache area 430-1 of the SLC region 430), and storage space of two SBs are allocated for the QLC cache space (for example, the storage space including the QLC cache area 400-2 of the SLC region 400, the QLC cache area 420-2 of the SLC region 420, the QLC cache area 410-2 of the SLC region 410, and the QLC cache area 430-2 of the SLC region 430).

Information about the storage segmentations as described above may be stored in one or more tables, and the table(s) is(are) stored in the designated page(s) of the system block of the flash module 150 before the device side including the flash controller 130 and the flash module 150 leaves the manufacturing factory. The tables are read from the designated page(s) of the flash module 150 to obtain the storage segmentation information, and are stored in the RAM 136 for reference during normal operations after the device side leaves the manufacturing factory.

In some embodiments, a super-block management table is provided to store information about the profile of every SB. Exemplary data structure of the super-block management table is shown as Table 1:

TABLE 1

| Field Name | Description |
|---|---|
| SB_No | Super-block Number |
| Type | 0: TLC cache of SLC region |
| | 1: QLC cache of SLC region |
| | 2: TLC region |
| | 3: QLC region |

The field “SB_No” records a super-block number of a specific SB and the field “Type” records information indicating that the specific SB is used as the TLC cache of the SLC region, the QLC cache of the SLC region, the TLC region or the QLC region. For example, the super-block management table is initialized to contain two records: {0,0}; and {1,0} to indicate that the super blocks SB#0 and SB#1 are used as the TLC cache space of the SLC regions. Two records: {2,1}; and {3,1} are initialized and stored in the super-block management table to indicate that the super blocks SB#2 and SB#3 are used as the QLC cache space of the SLC regions. Ten records: {4,2}; {5,2}; to {13,2} are initialized and stored in the super-block management table to indicate that the super blocks SB#4, SB#5 to SB#13 are used as the TLC regions. Ten records: {14,3}; {15,3}; to {23,3} are initialized and stored in the super-block management table to indicate that the super blocks SB#14, SB#15 to SB#23 are used as the QLC regions. The records of the super-block management table after being initialized stored in the system block cannot be modified. Those skilled in the art may realize the information stored in the super-block management table in different data structure, such as a linked list, or others.

A physical-block management table is provided to store information about the profile of every physical block. Each record in the physical-block management table stores information at least indicating which SB a corresponding physical block is associated with. Exemplary data structure of the physical-block management table is shown in Table 2:

TABLE 2

| Field Name | Description |
|---|---|
| LUN | Logical Unit Number |
| Plane_No | Data Plane Number |
| Block_No | Physical Block Number |
| SB_No | Super-block Number |
| Empty_Page_Start | Page Number of Beginning Empty |
| | Page |

The field “LUN” records a LUN of a specific die of a specific NAND flash unit (for example, “0”, “1”, “2”, “3”, “4”, “5”, “6”, “7” stand for the 0^{th} die and the 1^{st} die of the NAND flash units 153#0, the 0^{th} die and the 1^{st} die of the NAND flash units 153#2, the 0^{th} die and the 1^{st} die of the NAND flash units 153#1, and the 0^{th} die and the 1^{st} die of the NAND flash units 153#3, respectively) that a specific physical block is located in, the field “Plane_No” records a data plane number of a specific data plane that the specific physical block is located in (for example, “0” and “1” stands for the 0^{th} and the 1^{st} planes, respectively), the field “Block_No” records a physical block number of the specific physical block, the field “SB_No” records a super-block number of a specific SB that the physical block is included in, and the field “Empty_Page_Start” records a page number of a beginning empty page in the specific physical block of the specific data plane of the specific die of the specific NAND flash unit. If the field “Empty_Page_Start” of a record stores a NULL value, it means that the specific physical block is filled with data and becomes a data block. The physical-block management table is initialized as an empty table before the device side leaves the manufacturing factory, and records are appended to the physical-block management table during the normal operations after the device side leaves the manufacturing factory. The up-to-date physical-block management table is programmed into empty pages of the system block of the flash module 150 when a specific condition is satisfied, for example, when the device side is determined to shutdown.

For an example, before programming user data of one or more SPs into the TLC cache space of the flash module 150 that stores no user data, the processing unit 134 selects an empty physical block (e.g. the 1^{st} physical block) of every data plane of every die of every NAND flash unit as a current block. The processing unit 134 creates and appends sixteen records: {0,0,1,0,0}; {0,1,1,0,0}; {1,0,1,0,0}; {1,1,1,0,0}; {2,0,1,0,0}; {2,1,1,0,0}; {3,0,1,0,0}; {3,1,1,0,0}; {4,0,1,0,0}; {4,1,1,0,0}; {5,0,1,0,0}; {5,1,1,0,0}; {6,0,1,0,0}; {6,1,1,0,0}; {7,0,1,0,0}; and {7,1,1,0,0} to the physical-block management table stored in the RAM 136. Joining with the exemplary records provided for Table 1, the sixteen records state that the 1^{st} physical blocks of the 0^{th} and the 1^{st} data planes of the 0^{th} die and the 1^{st} die of the NAND flash units 153#0, 153#2, 153#1 and 153#3 form an SB with the super-block number “0” (i.e. SB#0) collectively, where the super block SB#0 is used as the TLC cache space of the SLC regions.

For another example, after the physical blocks in the SB with the super-block number “2” (i.e. SB#2), which is assigned for the QLC cache of the SLC region, is filled with user data, the processing unit 134 selects an empty physical block (e.g. the 4^{th} physical block) of every data plane of every die of every NAND flash unit as a current block. The processing unit 134 creates and appends sixteen records: {0,0,4,3,0}; {0,1,4,3,0}; {1,0,4,3,0}; {1,1,4,3,0}; {2,0,4,3,0}; {2,1,4,3,0}; {3,0,4,3,0}; {3,1,4,3,0}; {4,0,4,3,0}; {4,1,4,3,0}; {5,0,4,3,0}; {5,1,4,3,0}; {6,0,4,3,0}; {6,1,4,3,0}; {7,0,4,3,0}; and {7,1,4,3,0} to the physical-block management table stored in the RAM 136. Joining with the exemplary records provided for Table 1, the sixteen records state that the 4^{th} physical blocks of the 0^{th} and the 1^{st} data planes of the 0^{th} die and the 1^{st} die of the NAND flash units 153#0, 153#2, 153#1 and 153#3 form an SB with the super-block number “3” collectively, where the super block SB#3 is used as the QLC cache space of the SLC regions.

Exemplary new data access operations with the new sharing policy for the hybrid architecture of the flash module 150 are provided as follows: Referring to FIG. 6, in the beginning, for user data that would be stored in the TLC regions 405 and 425, a fast-programming process is performed to program the user data into empty pages of physical blocks associated with an SB (e.g. the SB 600) across the TLC cache areas 400-1, 420-1, 410-1 and 430-1 in the interleave manner until a total number of empty SBs (or empty physical blocks) of the TLC cache areas 400-1, 420-1, 410-1 and 430-1 is less than a predefined SLC-empty-block threshold. The storage capacity of each SB across the TLC cache areas 400-1, 420-1, 410-1 and 430-1 as shown in FIG. 6 is about two times the storage capacity of each SB across the SLC regions 400 and 420 as shown in FIG. 5. Comparing with the implementations as shown in FIG. 5, the interleave programming as shown in FIG. 6 involves distributing data across more NAND flash units (i.e. not only the TLC NAND flash units 153#0 and 153#2, but also the QLC NAND flash units 153#1 and 153#3) to increase the data throughput between the flash I/F 139 and the I/F 151, and decrease write latency of the data programming operations. Once a total number of empty SBs (or empty physical blocks) of the TLC cache areas 400-1, 420-1, 410-1 and 430-1 is less than the predefined SLC-empty-block threshold, a SLC to TLC folding process is performed to collect user data of physical blocks (e.g. the data blocks 600) of the TLC cache areas 400-1, 420-1, 410-1 and 430-1 and program the collected user data into empty pages of physical blocks (e.g. the current blocks 605) associated with an SB across the TLC regions 405 and 425 in the interleave manner. Those skilled in the art would comprehend that user data of three SPs of the TLC cache areas 400-1, 420-1, 410-1 and 430-1 can be collected and programmed into two SPs of the TLC regions 405 and 425. Comparing with the implementations as shown in FIG. 5, the interleave read as shown in FIG. 6 involves reading data across more NAND flash units (i.e. not only the TLC NAND flash units 153#0 and 153#2, but also the QLC NAND flash units 153#1 and 153#3) to increase the data throughput between the flash I/F 139 and the I/F 151, and/or decrease read latency of the data read operations in the SLC to TLC folding process. After a total number of empty SBs (or empty physical blocks) of the TLC regions 405 and 425 is less than a predefined TLC-empty-block threshold, a TLC direct write process is performed to continuously collect user data of at least three SPs from the host side 110 and program the collected data into empty pages of physical blocks (e.g. the current blocks 607) associated with an SB across the TLC regions 405 and 425 in the interleave manner. Those skilled in the art would comprehend that user data of three SPs can be collected from the host side 110 and programmed into one empty SP of the TLC regions 405 and 425. After a total number of empty SBs (or empty physical blocks) of the TLC regions 405 and 425 is less than a predefined TLC-GC threshold, a background GC process and/or a foreground GC process is performed to collect valid user data of data blocks of the TLC regions 405 and 425 and program the collected user data into empty pages of current blocks associated with an SB of the TLC regions 405 and 425 in the interleave manner. The predefined TLC-GC threshold is less than the predefined TLC-empty-block threshold.

Referring to FIG. 7, for user data that would be stored in the QLC regions 415 and 435, in the beginning, a fast-programming process is performed to program the user data into empty pages of physical blocks associated with an SBs (e.g. the SB 700) across the QLC cache areas 400-2, 420-2, 410-2 and 430-2 in the interleave manner until a total number of empty SBs (or empty physical blocks) of the QLC cache areas 400-2, 420-2, 410-2 and 430-2 is less than a predefined SLC-empty-block threshold. The storage capacity of each SB across the QLC cache areas 400-2, 420-2, 410-2 and 430-2 as shown in FIG. 7 is about two times the storage capacity of each SB across the QLC regions 410 and 430 as shown in FIG. 5. Comparing with the implementations as shown in FIG. 5, the interleave programming as shown in FIG. 7 involves distributing data across more NAND flash units (i.e. not only the QLC NAND flash units 153#1 and 153#3, but also the TLC NAND flash units 153#0 and 153#2) to increase the data throughput between the flash I/F 139 and the I/F 151, and decrease write latency of the data programming operations. Once a total number of empty SBs (or empty physical blocks) of the QLC cache areas 400-2, 420-2, 410-2 and 430-2 is less than the predefined SLC-empty-block threshold, a SLC to QLC folding process is performed to collect user data of physical blocks (e.g. the data blocks 700) of the QLC cache areas 400-2, 420-2, 410-2 and 430-2 and program the collected user data into empty pages of physical blocks (e.g. the current blocks 705) associated with an SB across the QLC regions 415 and 435 in the interleave manner. Those skilled in the art would comprehend that user data of two SPs of the QLC cache areas 400-2, 420-2, 410-2 and 430-2 can be collected and programmed into one SP of the QLC regions 415 and 435. Comparing with the implementations as shown in FIG. 5, the interleave read as shown in FIG. 7 involves reading data across more NAND flash units (i.e. not only the QLC NAND flash units 153#1 and 153#3, but also the TLC NAND flash units 153#0 and 153#2) to increase the data throughput between the flash I/F 139 and the I/F 151, and/or decrease read latency of the data read operations in the SLC to QLC folding process. After a total number of empty SBs (or empty physical blocks) of the QLC regions 415 and 435 is less than a predefined QLC-GC threshold, a background GC process and/or a foreground GC process is performed to collect valid user data of the data blocks of the QLC regions 415 and 435 and program the collected user data into empty pages of current blocks associated with an SB of the QLC regions 415 and 435 in the interleave manner.

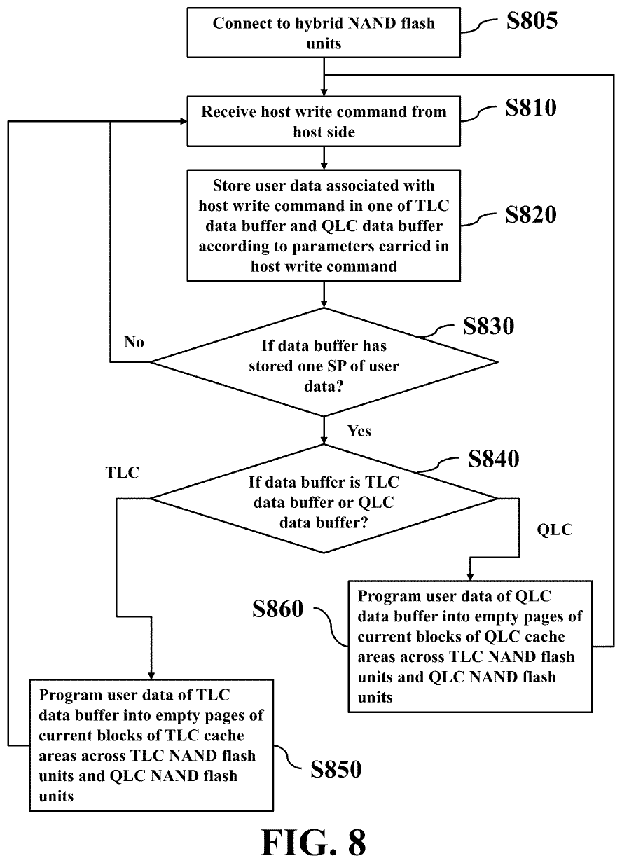

With the new sharing policy for the hybrid architecture of the flash module 150, the flash controller 130 (specifically, the processing unit 134) performs a method for the fast-programming process. Refer to FIG. 8 showing the method for the fast-programming process in the data access operations of the hybrid architecture, which is performed by the processing unit 134. Details are described as follows:

Step S805: The flash module 150 with the storage segmentations as shown in FIGS. 6 and 7 is connected to. The flash module 150 is connected by the processing unit 134 after completing the system booting process. The system booting process includes a wide range of hardware tests to the flash module 150, reading of the program code of firmware translation layer (FTL) and necessary system information from system blocks of the flash module 150 and the storing of the program code of FTL and necessary system information in the RAM 136, and others. The system information at least includes the super-block management table and the physical-block management table to realize the new sharing policy. The super-block management table has multiple records and every records stores information indicating that a specific super block is provided across the TLC cache areas 400-1, 420-1, 410-1 and 430-1, across the QLC cache areas 400-2, 420-2, 410-2 and 430-2, across the TLC regions 405 and 425, or across the QLC regions 415 and 435.

Subsequently, a loop including steps S810 to S860 is repeatedly executed by the processing unit 134 when loading and executing the program code of FTL for programming user data obtained from the host side 110 through the host I/F 131 into the flash module 150 through the flash I/F 139.

Step S810: A host write command is received from the host side 110 through the host I/F 131. For example, the host side 110 transmits the command UFS Protocol Information Unit (UPIU) to the flash controller 130 to instruct the flash controller 130 to program user data of a specific logical address range into the flash controller 130.

Step S820: User data associated with the host write command is stored in one of a TLC data buffer and a QLC data buffer according to one or more parameters carried in the host write command. Certain space of the RAM 136 is allocated for the TLC data buffer and the QLC data buffer. The TLC data buffer is used to temporarily store user data obtained from the host side 110, which would be stored in the TLC regions 405 and 425. The QLC data buffer is used to temporarily store user data obtained from the host side 110, which would be stored in the QLC regions 415 and 435.

In some embodiments, data type of the user data associated with the host write command is first determined according to the parameter(s) carried in the host write command. For example, the command UPIU carries information of the data type of the user data in the group number field of the command UPIU. The group number field is located in bit[4:0] of the 22^{th} byte of the command UPIU. The host side 110 sets the value of the data type to “0h” to indicate that the user data is infrequent-updated data (also referred to as cold data), otherwise, sets that to “1h” to indicate that the user data is frequent-updated data (also referred to as hot data). The processing unit 134 stores the user data in the QLC data buffer when detecting that the data type of the user data is cold data. Otherwise, the processing unit 134 stores the user data in the TLC data buffer when detecting that the data type of the user data is hot data.

In alternative embodiments, an LBA or an LBA range carried in the host write command is first determined. For example, the host side 110 preserves a first LBA range for system data (e.g. LBA#0 to LBA#1024) and a second LBA range for application data (e.g. LBA#1025 and the greater). It is noted that the first LBA range and the second LBA range are not overlapped. The processing unit 134 stores the user data in the TLC data buffer when detecting that the LBA or the LBA range carried in the host write command falls within the first LBA range. Otherwise, the processing unit 134 stores the user data in the TLC or QLC data buffer when detecting that the LBA or the LBA range carried in the host write command falls within the second LBA range.

In alternative embodiments, a length of the user data, which is carried in the host write command, is first determined. The processing unit 134 determines that the host write command is a random write command and stores the user data in the TLC data buffer when detecting that the length of the user data is shorter than a threshold. Otherwise, determines that the host write command is a sequential write command and stores the user data in the QLC data buffer when detecting that the length of the user data is equal to or longer than the threshold. The threshold may be set to 4K, 16K or 32K bytes.

Step S830: It is determined whether the data buffer, which stores the user data in step S820, has stored one SP of user data. If so, then the process proceeds to step S840. Otherwise, the process proceeds to step S810 for collecting more data in the data buffer.

Step S840: It is determined whether the data buffer, which stores the user data in step S820, is the TLC data buffer or the QLC data buffer. If the data buffer is the TLC data buffer, then the process proceeds to step S850. If the data buffer is the QLC data buffer, then the process proceeds to step S860.

Step S850: The user data stored in the TLC data buffer is programmed into empty pages of current blocks across the TLC cache area 400-1 of the TLC NAND flash unit 153#0, the TLC cache area 420-1 of the TLC NAND flash unit 153#2, the TLC cache area 410-1 of the QLC NAND flash unit 153#1, and the TLC cache area 430-1 of the QLC NAND flash unit 153#3 in the interleave manner. The programmed empty pages of current pages form an SP. The super-block management table and the physical-block management table are searched to obtain information about specific empty pages of specific current blocks across the TLC cache area 400-1 of the TLC NAND flash unit 153#0, the TLC cache area 420-1 of the TLC NAND flash unit 153#2, the TLC cache area 410-1 of the QLC NAND flash unit 153#1, and the TLC cache area 430-1 of the QLC NAND flash unit 153#3 for programming the user data of the TLC data buffer.

Step S860: The user data stored in the QLC data buffer is programmed into empty pages of current blocks across the QLC cache area 400-2 of the TLC NAND flash unit 153#0, the QLC cache area 420-2 of the TLC NAND flash unit 153#2, the QLC cache area 410-2 of the QLC NAND flash unit 153#1, and the QLC cache area 430-2 of the QLC NAND flash unit 153#3 in the interleave manner. The programmed empty pages of current pages form an SP. The super-block management table and the physical-block management table are searched to obtain information about specific empty pages of specific blocks across the QLC cache area 400-2 of the TLC NAND flash unit 153#0, the QLC cache area 420-2 of the TLC NAND flash unit 153#2, the QLC cache area 410-2 of the QLC NAND flash unit 153#1, and the QLC cache area 430-2 of the QLC NAND flash unit 153#3 for programming the user data of the QLC data buffer.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims.

One having ordinary skill in the art will readily understand that the invention as discussed above may be practiced with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent.” etc.)

The term “device” or “module” is not limited to one or a specific number of physical objects (such as one smartphone, one controller, one processing system and so on). As used herein, a device may be any electronic device with one or more parts that may implement at least some portions of the invention in this disclosure. While the description and examples use the term “device” or “module” to describe various aspects of this disclosure, the term “device” or “module” is not limited to a specific configuration, type, or number of objects. Additionally, the term “system” or “module” is not limited to multiple components or specific aspects. For example, a system may be implemented on one or more printed circuit boards or other substrates and may have movable or static components. While the description and examples use the term “system” to describe various aspects of the invention in this disclosure, the term “system” is not limited to a specific configuration, type, or number of objects.

Specific details are provided in the description above to provide a thorough understanding of the aspects and examples provided herein. However, it will be understood by one of ordinary skills in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Some or all of the aforementioned embodiments of the method of the invention may be implemented in a computer program such as a driver for a dedicated hardware, a Firmware Translation Layer (FTL) of a storage device, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Although the embodiment has been described as having specific elements in FIGS. 1-3, it should be noted that additional elements may be included to achieve better performance without departing from the spirit of the invention. Each element of FIGS. 1-3 is composed of various circuitries and arranged to operably perform the aforementioned operations. While the process flows described in FIG. 8 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for operating hybrid NAND flash units, performed by a processing unit of a flash controller, comprising:
connecting to a flash module comprising a first NAND flash unit, a second NAND flash unit, a third NAND flash unit and a fourth NAND flash unit; and
programming user data obtained from a host side into the flash module,
wherein a first channel is connected to the first NAND flash unit and the second NAND flash unit, a second channel is connected to the third NAND flash unit and the fourth NAND flash unit, the first NAND flash unit and the third NAND flash unit are activated by a first chip enable signal, and the second NAND flash unit and the fourth NAND flash unit are activated by a second chip enable signal,
wherein storage space of the first NAND flash unit comprises a first region and a second region, storage space of the second NAND flash unit comprises a third region and a fourth region, storage space of the third NAND flash unit comprises a fifth region and a sixth region, and storage space of the fourth NAND flash unit comprises a seventh region and an eighth region,
wherein storage space of the first region comprises a first area and a second area, storage space of the third region comprises a third area and a fourth area, storage space of the fifth region comprises a fifth area and a sixth area, and storage space of the seventh region comprises a seventh area and an eighth area,
wherein the first area, the third area, the fifth area and the seventh area jointly provide cache space for the second region and the sixth region, and the second area, the fourth area, the sixth area and the eighth area jointly provide cache space for the fourth region and the eighth region.

2. The method of claim 1, wherein the first region, the third region, the fifth region and the seventh region are single level cell (SLC) regions, the second region and the sixth region are triple level cell (TLC) regions, the fourth region and the eighth region are quad-level cell (QLC) regions.

3. The method of claim 1, comprising:
reading a super-block management table comprising a plurality of records from a system block of the flash module, wherein every record stores information indicating that a specific super block is provided across the first area, the fifth area, the third area and the seventh area, across the second area, the sixth area, the fourth area and the eighth area, across the second region and the sixth region, or across the fourth region and the eighth region.

4. The method of claim 1, comprising:
programming hot data associated with a first host write command issued by the host side into empty pages of current blocks across the first area, the fifth area, the third area and the seventh area in an interleave manner; and
programming cold data associated with a second host write command issued by the host side into empty pages of current blocks across the second area, the sixth area, the fourth area and the eighth area in the interleave manner.

5. The method of claim 4, wherein an indication of the hot data is carried in a group number field of a first command UFS protocol information unit (UPIU) corresponding to the first host write command, and an indication of the cold data is carried in a group number field of a second command UPIU corresponding to the second host write command.

6. The method of claim 1, comprising:
programming user data associated with a first logical address falling within a first logical address range or a second logical address range, which is indicated in a first host write command issued by the host side, into empty pages of current blocks across the first area, the fifth area, the third area and the seventh area in an interleave manner; and
programming user data associated with a second logical address falling within the second logical address range, which is indicated in a second host write command issued by the host side, into empty pages of current blocks across the second area, the sixth area, the fourth area and the eighth area in the interleave manner,
wherein the first logical address range and the second logical address range are not overlapped.

7. The method of claim 1, comprising:
programming user data associated with a first length shorter than a threshold, which is indicated in a first host write command issued by the host side, into empty pages of current blocks across the first area, the fifth area, the third area and the seventh area in an interleave manner; and
programming user data associated with a second length equal to or longer than the threshold, which is indicated in a second host write command issued by the host side, into empty pages of current blocks across the second area, the sixth area, the fourth area and the eighth area in the interleave manner,
wherein the threshold is set to 4K, 16K or 32K bytes.

8. A non-transitory computer-readable storage medium having stored therein program code that, when loaded and executed by a processing unit of a flash controller, causes the processing unit to:
connect to a flash module comprising a first NAND flash unit, a second NAND flash unit, a third NAND flash unit and a fourth NAND flash unit; and
program user data obtained from a host side into the flash module,
wherein a first channel is connected to the first NAND flash unit and the second NAND flash unit, a second channel is connected to the third NAND flash unit and the fourth NAND flash unit, the first NAND flash unit and the third NAND flash unit are activated by a first chip enable signal, and the second NAND flash unit and the fourth NAND flash unit are activated by a second chip enable signal,
wherein storage space of the first NAND flash unit comprises a first region and a second region, storage space of the second NAND flash unit comprises a third region and a fourth region, storage space of the third NAND flash unit comprises a fifth region and a sixth region, and storage space of the fourth NAND flash unit comprises a seventh region and an eighth region,
wherein storage space of the first region comprises a first area and a second area, storage space of the third region comprises a third area and a fourth area, storage space of the fifth region comprises a fifth area and a sixth area, and storage space of the seventh region comprises a seventh area and an eighth area,
wherein the first area, the third area, the fifth area and the seventh area jointly provide cache space for the second region and the sixth region, and the second area, the fourth area, the sixth area and the eighth area jointly provide cache space for the fourth region and the eighth region.

9. The non-transitory computer-readable storage medium of claim 8, wherein the first region, the third region, the fifth region and the seventh region are single level cell (SLC) regions, the second region and the sixth region are triple level cell (TLC) regions, the fourth region and the eighth region are quad-level cell (QLC) regions.

10. The non-transitory computer-readable storage medium of claim 8, wherein the program code that, when loaded and executed by the processing unit of the flash controller, causes the processing unit to:
read a super-block management table comprising a plurality of records from a system block of the flash module, wherein every record stores information indicating that a specific super block is provided across the first area, the fifth area, the third area and the seventh area, across the second area, the sixth area, the fourth area and the eighth area, across the second region and the sixth region, or across the fourth region and the eighth region.

11. The non-transitory computer-readable storage medium of claim 8, wherein the program code that, when loaded and executed by the processing unit of the flash controller, causes the processing unit to:
program hot data associated with a first host write command issued by the host side into empty pages of current blocks across the first area, the fifth area, the third area and the seventh area in an interleave manner; and
program cold data associated with a second host write command issued by the host side into empty pages of current blocks across the second area, the sixth area, the fourth area and the eighth area in the interleave manner,
wherein an indication of the hot data is carried in a group number field of a first command UFS protocol information unit (UPIU) corresponding to the first host write command, and an indication of the cold data is carried in a group number field of a second command UPIU corresponding to the second host write command.

12. The non-transitory computer-readable storage medium of claim 8, wherein the program code that, when loaded and executed by the processing unit of the flash controller, causes the processing unit to:
program user data associated with a first logical address falling within a first logical address range or a second logical address range, which is indicated in a first host write command issued by the host side, into empty pages of current blocks across the first area, the fifth area, the third area and the seventh area in an interleave manner; and
program user data associated with a second logical address falling within the second logical address range, which is indicated in a second host write command issued by the host side, into empty pages of current blocks across the second area, the sixth area, the fourth area and the eighth area in the interleave manner,
wherein the first logical address range and the second logical address range are not overlapped.

13. The non-transitory computer-readable storage medium of claim 8, wherein the program code that, when loaded and executed by the processing unit of the flash controller, causes the processing unit to:
program user data associated with a first length shorter than a threshold, which is indicated in a first host write command issued by the host side, into empty pages of current blocks across the first area, the fifth area, the third area and the seventh area in an interleave manner; and
program user data associated with a second length equal to or longer than the threshold, which is indicated in a second host write command issued by the host side, into empty pages of current blocks across the second area, the sixth area, the fourth area and the eighth area in the interleave manner,
wherein the threshold is set to 4K, 16K or 32K bytes.

14. An apparatus for operating hybrid NAND flash units, comprising:
a flash interface (I/F), coupled to a flash module comprising a first NAND flash unit, a second NAND flash unit, a third NAND flash unit and a fourth NAND flash unit, wherein a first channel is connected to the first NAND flash unit and the second NAND flash unit, a second channel is connected to the third NAND flash unit and the fourth NAND flash unit, the first NAND flash unit and the third NAND flash unit are activated by a first chip enable signal, and the second NAND flash unit and the fourth NAND flash unit are activated by a second chip enable signal, wherein storage space of the first NAND flash unit comprises a first region and a second region, storage space of the second NAND flash unit comprises a third region and a fourth region, storage space of the third NAND flash unit comprises a fifth region and a sixth region, and storage space of the fourth NAND flash unit comprises a seventh region and an eighth region, wherein storage space of the first region comprises a first area and a second area, storage space of the third region comprises a third area and a fourth area, storage space of the fifth region comprises a fifth area and a sixth area, and storage space of the seventh region comprises a seventh area and an eighth area, wherein the first area, the third area, the fifth area and the seventh area jointly provide cache space for the second region and the sixth region, and the second area, the fourth area, the sixth area and the eighth area jointly provide cache space for the fourth region and the eighth region; and
a processing unit, coupled to the flash I/F, arranged operably to: connect to the flash module; and program user data obtained from a host side into the flash module through the flash I/F.

15. The apparatus of claim 14, wherein the first region, the third region, the fifth region and the seventh region are single level cell (SLC) regions, the second region and the sixth region are triple level cell (TLC) regions, the fourth region and the eighth region are quad-level cell (QLC) regions.

16. The apparatus of claim 14, wherein the processing unit is arranged operably to: read a super-block management table comprising a plurality of records from a system block of the flash module through the flash I/F, wherein every record stores information indicating that a specific super block is provided across the first area, the fifth area, the third area and the seventh area, across the second area, the sixth area, the fourth area and the eighth area, across the second region and the sixth region, or across the fourth region and the eighth region.

17. The apparatus of claim 14, wherein the processing unit is arranged operably to: program hot data associated with a first host write command issued by the host side into empty pages of current blocks across the first area, the fifth area, the third area and the seventh area in an interleave manner through the flash I/F; and program cold data associated with a second host write command issued by the host side into empty pages of current blocks across the second area, the sixth area, the fourth area and the eighth area in the interleave manner through the flash I/F.

18. The apparatus of claim 14, wherein an indication of the hot data is carried in a group number field of a first command UFS protocol information unit (UPIU) corresponding to the first host write command, and an indication of the cold data is carried in a group number field of a second command UPIU corresponding to the second host write command.

19. The apparatus of claim 14, wherein the processing unit is arranged operably to: program user data associated with a first logical address falling within a first logical address range or a second logical address range, which is indicated in a first host write command issued by the host side, into empty pages of current blocks across the first area, the fifth area, the third area and the seventh area in an interleave manner through the flash I/F; and program user data associated with a second logical address falling within the second logical address range, which is indicated in a second host write command issued by the host side, into empty pages of current blocks across the second area, the sixth area, the fourth area and the eighth area in the interleave manner through the flash I/F, wherein the first logical address range and the second logical address range are not overlapped.

20. The apparatus of claim 14, wherein the processing unit is arranged operably to: program user data associated with a first length shorter than a threshold, which is indicated in a first host write command issued by the host side, into empty pages of current blocks across the first area, the fifth area, the third area and the seventh area in an interleave manner; and program user data associated with a second length equal to or longer than the threshold, which is indicated in a second host write command issued by the host side, into empty pages of current blocks across the second area, the sixth area, the fourth area and the eighth area in the interleave manner, wherein the threshold is set to 4K, 16K or 32K bytes.
